(19) United States
(12) Patent Application Publication
(10) Pub. No.: US 2007/0044889 A1
(43) Pub. Date: Mar. 1, 2007

(54) Tire having a sidewall reinforcement

(75) Inventors: Jie Jin, Stow, OH (US); Michael Crano, Fairlawn, OH (US)

Correspondence Address: Chief IP Counsel;Bridgestone Americas Holding, Inc., 1200 Firestone Parkway, Akron, OH, 44317, US

(73) Assignee: Bridgestone Firestone North American Tire, LLC

(21) Appl. No.: 11/217,738

(22) Filed: Sep. 1, 2005

(51) Int. Cl. B60C 9/00

(52) U.S. Cl. 152/555; 152/554

(57) ABSTRACT

A tire, which has a maximum section width, an upper section above the maximum section width, and a lower section below the maximum section width, includes a tread extending circumferentially about the tire, a pair of sidewalls, a pair of bead portions, and at least one carcass ply extending circumferentially about the tire from one bead portion to the other. The tire further includes a reinforcement ply extending circumferentially about the tire and being disposed between the at least one carcass ply and the tread and at least one of the sidewalls of the tire. The reinforcement ply has a lower end that terminates in the lower section of the tire.

### FIELD OF THE INVENTION

The present application relates to tires and, more particularly, to a tire with a sidewall reinforcement to improve sidewall performance of the tire.

### BACKGROUND

In an inflated and loaded condition, a radial tire is subject to bending moments at the sidewall areas at the center of the tire footprint. The strains and stresses created by the moments are directly related to the sidewall performance of the tire.

Previous research and studies have demonstrated that the maximum sidewall surface strain occurs in the least stiff area of the sidewall of a tire. Because of cord compression created during the loading of the tire, the combined cord tension in the upper sidewall area is reduced and that area is most vulnerable to sidewall bending. Therefore, the maximum sidewall surface strain is located in the upper sidewall area.

### SUMMARY

A tire, which has a maximum section width, an upper section above the maximum section width, and a lower section below the maximum section width, includes a tread extending circumferentially about the tire, a pair of sidewalls, a pair of bead portions, and at least one carcass ply extending circumferentially about the tire from one bead portion to the other. The tire further includes a reinforcement ply extending circumferentially about the tire and being disposed between the at least one carcass ply the tread and at least one of the sidewalls of the tire. The reinforcement ply has a lower end that terminates in the lower section of the tire.

### BRIEF DESCRIPTION OF DRAWINGS

The accompanying drawings, together with the detailed description provided below, describe exemplary embodiments of the claimed invention. In the drawings and description that follow, like elements are identified with the same reference numerals. The drawings are not to scale and the proportion of certain elements may be exaggerated for the purpose of illustration.

FIG. 1 is a cross-sectional view of one embodiment of half of a tire 100.

FIG. 2 is an enlarged perspective view of a portion of the tire 100 of FIG. 1.

FIG. 3 is a perspective view of one embodiment of a portion of a reinforcement ply provided in the tire 100 of FIG. 1.

FIG. 4 is a sidewall surface strain plot comparing a P255/45R18 tire with and without a sidewall reinforcement.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Circumferential” and “circumferentially” refer to lines or directions extending along the perimeter of the surface of the tread parallel to the equatorial plane and perpendicular to the axial direction of the tire.

“Equatorial plane” refers to the plane that is perpendicular to the tire's axis of rotation and passes through the center of the tire's tread.

“Groove” refers to an elongated void area in the tread of the tire that extends circumferentially in a straight, curved or zig-zag manner.

“Lateral” or “laterally” refer to a direction along the tread of the tire going from one sidewall of the tire to the other sidewall.

“Radial” or “radially,” as used herein, refer to a direction perpendicular to the axis of rotation of the tire.

“Sidewall” refers to that portion of the tire between the tread and the bead.

“Tread” refers to that portion of the tire that comes into contact with the road under normal load.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

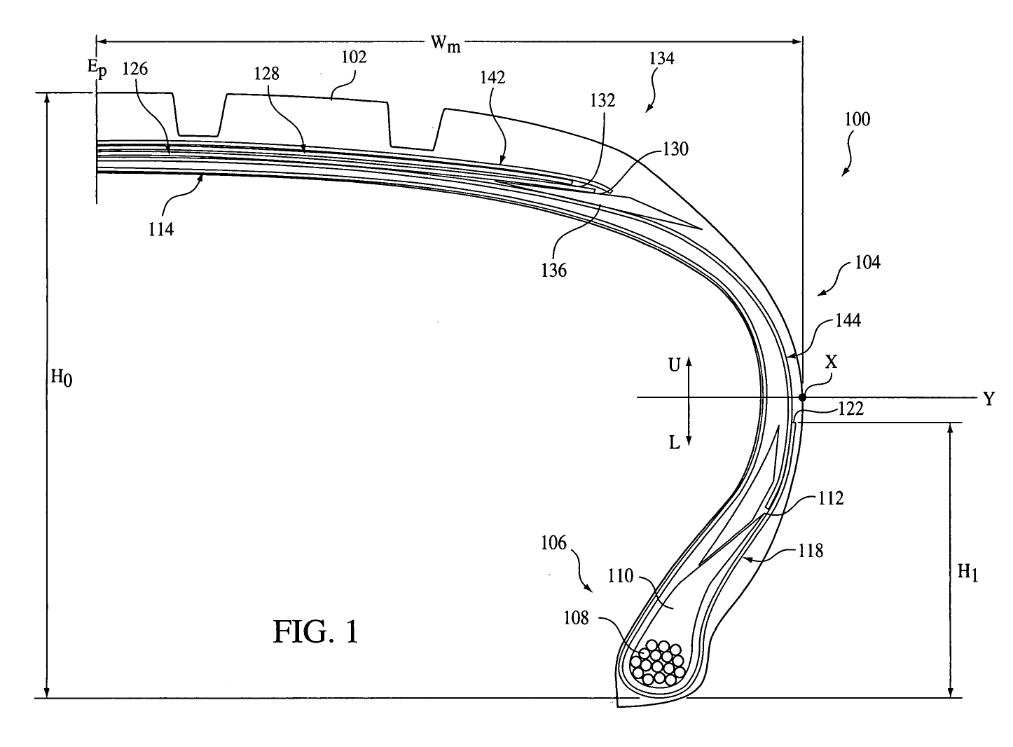

Illustrated in FIG. 1 is a cross-sectional view of half of one embodiment of a tire 100. Although only half of the tire 100 is depicted in the drawings, it will be appreciated that the other half of the tire 100 is a substantial mirror image of the half depicted. The tire 100 has an equatorial plane Eₚ and a maximum section width Wₘ measured from the equatorial plane Eₚ to the outer most point of the tire 100 (i.e., point X). The tire 100 can be divided into two sections—an upper section U and a lower section L. Separating the upper section U from the lower section L is a hypothetical line Y drawn through point X that is substantially parallel to the axis of rotation of the tire 100. The upper section U is the portion of the tire 100 that is disposed above the maximum section width Wₘ of the tire 100 (represented by line Y), while the lower section L is disposed below the maximum section width Wₘ of the tire 100 (represented by line Y).

With continued reference to FIG. 1, the tire 100 includes a tread 102 provided in the upper section U of the tire 100, a sidewall 104 provided in both the upper and lower sections U, L of the tire 100, and a bead portion 106 provided in the lower section L of the tire 100. The bead portion 106 includes a bead core 108 and a bead filler 110 having an upper end 112.

The tire 100 includes a carcass ply 114 that extends circumferentially about the tire 100 from one bead portion (e.g., bead portion 106) to the other bead portion (not shown). The carcass ply 114 is wound outwardly about the bead core 108 and extends upwardly towards the tread 102 to form a turn-up portion 118. The turn-up portion 118 terminates at a turn-up end 122. Although the tire 100 illustrated in FIG. 1 includes one carcass ply, the tire 100 can include two or more carcass plies in alternative embodiments (not shown).

With continued reference to the embodiment illustrated in FIG. 1, the turn-up portion 118 of the carcass ply 114 has a height H₁ measured radially from the turn-up end 122 to the base of the bead core 108. Preferably, the height H₁ of the first turn-up portion 118 is between about 30% and about 70% of the section height H₀ (which is measured from the outer tread surface at the equatorial plane Eₚ to the base of the bead core 108). In alternative embodiments (not shown), the height H₁ of the first turn-up portion 118 may be less than 30% or greater than 70% of the section height H₀ depending on the design.

In one embodiment, the carcass ply 114 includes parallel-aligned cords that are radially disposed. In other words, the parallel-aligned cords are oriented substantially perpendicular to the equatorial plane Eₚ of the tire 100. In alternative embodiments, the carcass ply can include parallel-aligned cords that are biased with respect to the equatorial plane Eₚ of the tire 100. In all cases, the cords can be constructed of, for example, nylon or polyester.

With continued reference to FIG. 1, the tire 100 further includes first and second belts 126, 128 that extend circumferentially about the tire 100. The first and second belts 126, 128 are provided between the tread 102 and the first and second carcass plies 114, 116 as shown in FIG. 1. The first and second belts 126, 128 terminate at edges 130, 132, respectively, at a location near a shoulder region 134 of the tire 100. Although the tire 100 illustrated in FIG. 1 features two belts, the tire 100 can include a single belt or more than two belts in alternative embodiments (not shown).

In one embodiment, the first and second belts 126, 128 include parallel-aligned cords or wires that are radially disposed. In alternative embodiments, one or more of the belts can include parallel-aligned cords or wires that are biased with respect to the equatorial plane Eₚ of the tire 100. In all cases, the cords or wires can be constructed of, for example, steel or other steel alloys.

With continued reference to FIG. 1, the tire 100 also includes a belt edge insert 136 provided in the shoulder region 134 of the tire 100 between the edges 130, 132 of the first and second belts 126, 128, respectively, and the carcass ply 114. The belt edge insert 136 has an inner end 138 and an outer end 140. The belt edge insert 136 is configured to protect the carcass ply 114 from the edges of the belts 126, 128. The belt edge insert 136 is constructed of extruded rubber, but may be constructed of another elastomeric material. Although shown in the FIG. 1 embodiment, the belt edge insert 136 is optional and may be omitted in alternative embodiments (not shown).

The tire 100 further includes a tread cap 142 provided between the tread 102 and the first and second belts 126, 128. The tread cap 142 can be used to assist in holding the components of the tire together (e.g., the belts, plies, and tread). The tread cap 142 can include, for example, one or more polyester or nylon fabric plies. Although shown in the FIG. 1 embodiment, the tread cap 142 is optional and may be omitted in alternative embodiments (not shown).

As shown in FIG. 1, the tire 100 also includes a reinforcement ply 144 that extends circumferentially about the tire 100. Although the tire 100 features a single reinforcement ply 144, it can include two or more reinforcement plies in alternative embodiments (not shown).

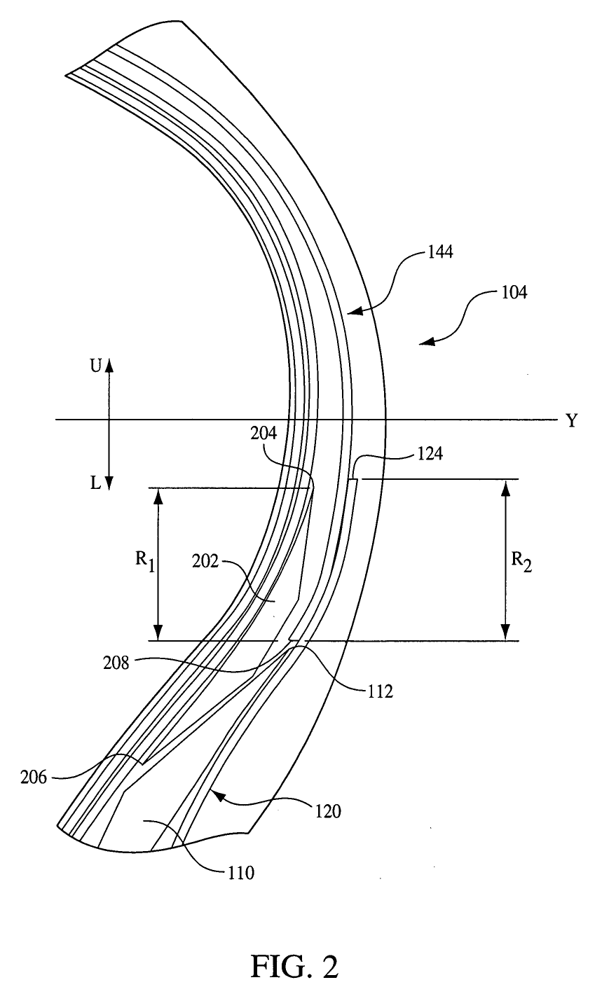

Illustrated in FIG. 2 is an enlarged perspective view of a portion of the tire 100 of FIG. 1 depicting the positioning of the reinforcement ply 144 in the tire 100 in greater detail. The reinforcement ply 144 is provided between the carcass ply 114 and the tread 102 and sidewall 104 (or portion thereof) of the tire 100.

With continued reference to FIG. 2, the tire 100 also includes a bead filler insert 202 having an upper end 204 and a lower end 206. The bead filler insert 202 is positioned above the bead filler 112 and between the reinforcement ply 144 and the carcass ply 114. The bead filler insert 202 is configured to serve as a cushion between the reinforcement ply 144 and the carcass ply 114. The bead filler insert 202 is constructed of rubber, but may be constructed of another elastomeric material. Although the bead filler insert 202 is illustrated as a separate component, it can be an extension of the bead filler 112.

As shown in FIG. 2, the reinforcement ply 144 has a lower end 208 that terminates in the lower section L of the tire 100. More specifically, the lower end 208 of the reinforcement ply 144 may extend below the upper end 204 of the bead filler insert 202. In other words, the bead filler insert 202 may overlap the reinforcement ply 144. Preferably, the lower end 208 of the reinforcement ply 144 extends below the upper end 204 of the bead filler insert 202 a radial distance R₁ between about 10 mm and about 15 mm. In alternative embodiments, the radial distance R₁ can be less than about 10 mm or greater than about 15 mm depending on the design.

The termination of the lower end 208 of the reinforcement ply 144 can also be discussed in relation to the turn-up end 124 of the carcass ply 114. For example, the lower end 208 of the reinforcement ply 144 extends below the turn-up end 124 of the carcass ply 114. In other words, the turn-up portion 118 of the carcass ply 114 overlaps the lower end 208 of the reinforcement ply 144. Preferably, the lower end 208 of the reinforcement ply 144 extends below the turn-up end 124 of the carcass ply 114 a radial distance R₂ between about 10 mm and about 15 mm. In alternative embodiments, the radial distance R₂ can be less than about 10 mm or greater than about 15 mm.

Although FIGS. 1 and 2 illustrate only half of a cross-section of the tire 100, the reinforcement ply 144 extends to the other sidewall (not shown) of the tire 100 where the other lower ends (not shown) of the reinforcement ply 144 terminates in the lower section L of the other sidewall of the tire 100. Hence, the reinforcement ply 144 can be referred to as a “half-ply” reinforcement since it covers the upper half of the tire 100 and extends from the lower section L of one sidewall (e.g., sidewall 104) of the tire to the lower section L of the other sidewall (i.e., the sidewall not shown) of the tire 100. In an alternative embodiment (not shown), the reinforcement ply 144 can be provided in two or more pieces that, together, extend from at least a portion of one sidewall to at least a portion of the other sidewall. For example, one piece of the reinforcement ply can have an upper end that terminates at or near the equatorial plane Eₚ of the tire and a lower end that terminates in the lower section L of one sidewall of the tire, while a second piece of the reinforcement ply can have an upper end that terminates at or near the equatorial plane of the tire and a lower end that terminates in the lower section L of the other sidewall of the tire.

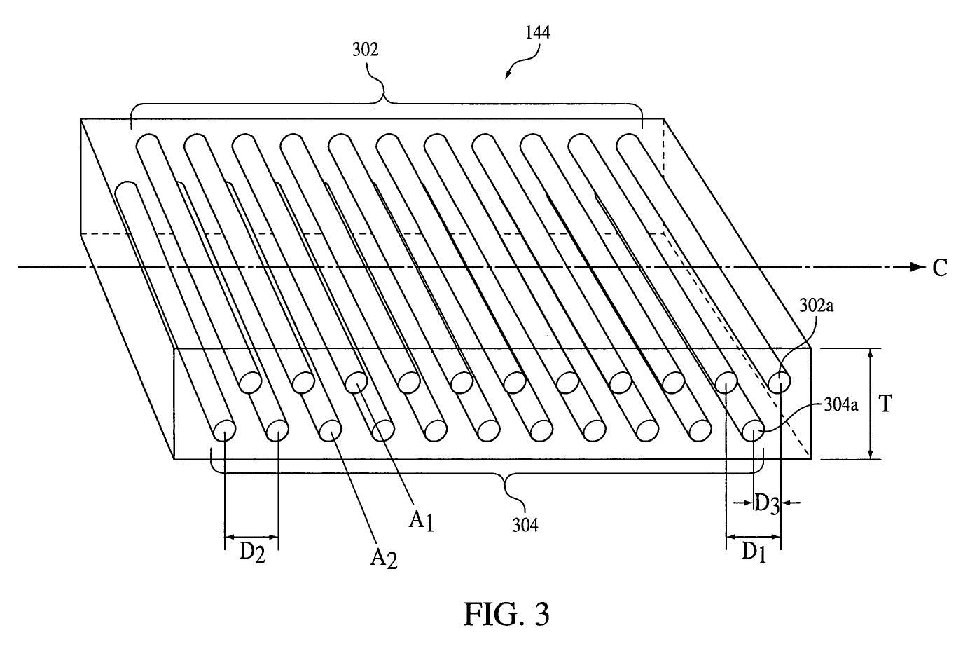

Illustrated in FIG. 3 is a perspective view of a portion of one embodiment of the reinforcement ply 144. The reinforcement ply 144 includes a first row of parallel-aligned cords 302 and a second row of parallel-aligned cords 304. Both rows of parallel-aligned cords 302, 304 are encapsulated in rubber or another elastomeric material.

As shown in FIG. 3, adjacent cords in the first row of parallel-aligned cords 302 are spaced apart from each other a distance D₁ measured from the center of each adjacent cord. Similarly, adjacent cords in the second row of parallel-aligned cords 304 are spaced apart from each other a distance D₂ measured from the center of each adjacent cord. Preferably, D₁ and D₂ are substantially equal to each other as shown in FIG. 3. However, D₁ and D₂ may differ from each other in alternative embodiments (not shown).

With reference to FIG. 3, each of the cords of the first row of parallel-aligned cords 302 have a longitudinal axis A₁ that is transversely oriented with respect to circumferential direction C of the tire 100. Similarly, each of the cords of the second row of parallel-aligned cords 304 have a longitudinal axis A₂ that is transversely oriented with respect to circumferential direction C of the tire 100. In alternative embodiments (not shown), one or both rows of parallel-aligned cords 302, 304 can be oriented at an acute angle with respect to the circumferential direction C of the tire 100 depending on the design. Also, the first and second rows of parallel-aligned cords 302, 304 are oriented substantially parallel to each other. However, in an alternative embodiment (not shown), the first and second rows of parallel-aligned cords 302, 304 may not be oriented substantially parallel to each other.

As shown in FIG. 3, the first row of parallel-aligned cords 302 is offset from the second row of parallel-aligned cords 304 in a direction substantially parallel to the circumferential direction C of the tire 100. In other words, the cords in the second row of parallel-aligned cords 304 are not substantially aligned with the cords in the first row of parallel-aligned cords 302. Instead, the second row of parallel-aligned cords 304 is shifted over from the first row of parallel-aligned cords 302 an offset distance D₃ measured from the center of cord 302a of the first row of parallel-aligned cords 302 to the center of cord 304a of second row of parallel-aligned cords 304. Preferably, the offset distance D₃ is about 50% of the distance D₁ between adjacent cords of the first row of parallel-aligned cords 302 (or the distance D₂ between adjacent cords of the second row of parallel-aligned cords 304). However, the offset distance D₃ may be less or greater than 50% in alternative embodiments (not shown).

The reinforcement ply 144 preferably has a thickness T between about 1.5 mm and about 2.5 mm. In alternative embodiments, the thickness T can be less than 1.5 mm or greater than 2.5 mm depending on the design.

In one embodiment, the first and second rows of parallel-aligned cords 302, 304 are constructed of nylon. In alternative embodiments, one or both rows of parallel-aligned cords 302, 304 may be constructed of polyester.

As shown in FIG. 3, the reinforcement ply 144 is illustrated as an integral component having two rows of cords disposed therein. In this case, the reinforcement ply 144 can be installed as a single component during the green tire assembly process. In an alternative embodiment (not shown), the first and second row of parallel-aligned cords 302, 304 can be provided as discrete layers that are installed separately during the green tire assembly process, yet cooperate with each to form the reinforcement ply 144 at the conclusion of the tire manufacturing process.

By providing the reinforcement in one or both sidewalls of a tire, sidewall performance of the tire is improved. For example, when the tire deflects, the reinforcement is shifted outward towards the sidewall of the tire, thereby increasing the stiffness of the sidewall of the tire. As stiffness of the sidewall of the tire increases, surface strain in the sidewall of the tire decreases. Reduction of surface strain in the sidewall of the tire can lead to a reduction of surface cracks at the sidewall of the tire, a reduction of deflection of the sidewall, and/or an improvement in vehicle handling.

The following example demonstrates the potential effects of providing the reinforcement in both sidewalls of a tire and should not be construed as limiting the scope or spirit of the present application.

### EXAMPLE 1

A P255/45R/18 tire, having a maximum allowable inflation of 35 psi and maximum load capacity of 1709 lb (hereinafter referred to as the “Control Tire”), was inflated to 19 psi (its minimum allowable inflation) and mounted on a fixture. A computer system was used to simulate the Control Tire to obtain dimensional data of the Control Tire in its unloaded state.

A maximum load of 1709 psi was then applied to the Control Tire causing it to deflect. The computer system then obtained dimensional data of the Control Tire in its loaded state. The dimensional data of the Control Tire in its unloaded state was then compared to the dimensional data of the Control Tire in its loaded state to determine actual strain values along various points on the sidewall of the Control Tire.

This dimensional data was also used to create a computer simulated model of the Control Tire. Modifications could be made to the computer simulated model of the Control Tire to create virtual tires. From these virtual tires, surface strain values along any point on the sidewall of a tire could be predicted. In this case, the computer simulated model of the Control Tire was modified to create a virtual tire that included a half-ply, single layer reinforcement (with nylon cords) similar to the one described above and shown in FIG. 3 (hereinafter be referred to as the “Reinforced Tire”).

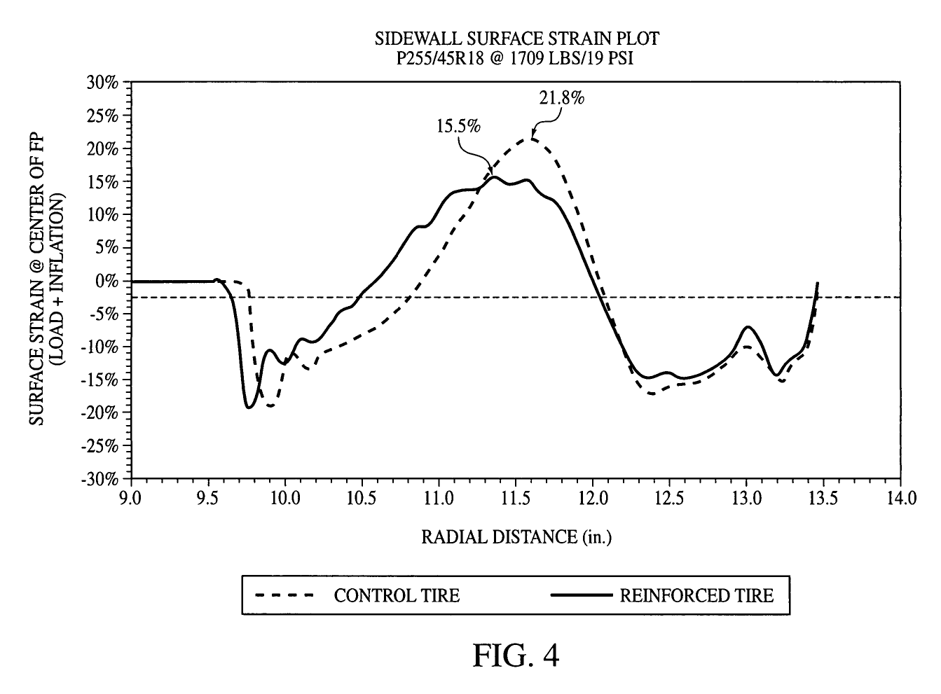

FIG. 4 illustrates the sidewall surface strain graph comparing the predicted surface strain values of the Control Tire with the predicted surface strain values of the Reinforced Tire. The x-axis represents the radial distance in inches from the axis of rotation of the tires, while the y-axis represents the surface strain at the center of the footprint of the tires. In this case, since both tires have a diameter of 18 inches, surface strain measurements were taken at a radial distance beginning at 9 inches and ending at about 13.5 inches (which is the end of the sidewall of the tires). As shown in the graph in FIG. 4, the predicted maximum sidewall surface strain of the Control Tire was 21.8%, while the predicted maximum sidewall surface strain of the Reinforced Tire was 15.5%. This represents a reduction in sidewall surface strain of about 6.3%.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's claimed invention.

1. A tire having a section height, a maximum section width, an upper section above the maximum section width, and a lower section below the maximum section width, the tire comprising:
a tread extending circumferentially about the tire;
a pair of sidewalls;
a pair of bead portions;
at least one carcass ply extending circumferentially about the tire from one bead portion to the other; and
a reinforcement ply extending circumferentially about the tire and being disposed between the at least one carcass ply and tread and at least one of the sidewalls of the tire, the reinforcement ply having a lower end that terminates in the lower section of the tire.

2. The tire of claim 1, wherein the reinforcement ply includes a first row of parallel-aligned cords and a second row of parallel-aligned cords spaced apart from the first row of parallel-aligned cords.

3. The tire of claim 2, wherein the first and second rows of parallel-aligned cords are oriented substantially parallel to each other.

4. The tire of claim 2, wherein the first and second rows of parallel-aligned cords are not oriented substantially parallel to each other.

5. The tire of claim 2, wherein the first and second rows of parallel-aligned cords have longitudinal axes that are transversely oriented with respect to a circumferential direction of the tire.

6. The tire of claim 2, wherein adjacent cords in the first row of parallel-aligned cords are spaced-apart from each other a first distance measured from the center of adjacent cords and adjacent cords in the second row of parallel-aligned cords are spaced-apart from each other a second distance measured from the center of adjacent cords.

7. The tire of claim 6, wherein the second row of parallel-aligned cords are offset from the first row of parallel-aligned cords an offset distance.

8. The tire of claim 7, wherein the offset distance is about 50% of the first distance between adjacent cords in the first row of parallel-aligned cords.

9. The tire of claim 2, wherein the first and second rows of the parallel-aligned cords are constructed of nylon.

10. The tire of claim 1, wherein the reinforcement ply has a thickness between about 1.5 mm and about 2.5 mm.

11. The tire of claim 1, wherein each bead portion includes a bead core and a bead filler.

12. The tire of claim 11, wherein the at least one carcass ply is wound outwardly about one of the bead cores and extends toward the tread to form a turn-up portion that terminates at a turn-up end, wherein the lower end of the reinforcement ply extends below the turn-up end of the at least one carcass ply.

13. The tire of claim 12, wherein the turn-up end of the turn-up portion is located in the lower section of the tire.

14. The tire of claim 12, wherein the turn-up portion has a height that is between about 30% and about 70% of the section height of the tire.

15. The tire of claim 12, wherein the lower end of the reinforcement ply extends below the turn-up end of the at least one carcass ply a radial distance between about 10 mm and about 15 mm.

16. The tire of claim 12, wherein the lower end of the reinforcement ply is provided between the at least one carcass ply and the turn-up portion of the at least one carcass ply.

17. The tire of claim 1, further comprising at least one belt extending circumferentially about the tire, the at least one belt provided between the tread and the at least one carcass ply.

18. The tire of claim 1, further comprising a bead filler insert provided above the bead filler and between the reinforcement ply and the at least one carcass ply.

19. The tire of claim 18, wherein the lower end of the reinforcement ply extends below an upper end of the bead filler insert.

20. The tire of claim 19, wherein the upper end of the bead filler insert extends above the lower end of the reinforcement ply and a lower end of the bead filler insert extends below an upper end of the bead filler.

21. A tire comprising:
a circumferentially extending tread;
a pair of sidewalls;
a belt layer underlying the tread;
a pair of bead assemblies;
at least one circumferentially extending carcass ply, the at least one carcass ply extends from one bead assembly to the other and includes at least one turn-up portion that extends upwardly towards the tread and terminates at a turn-up end; and
at least one circumferentially extending reinforcement ply disposed between the at least one carcass ply and the tread and at least one of the sidewalls of the tire, the reinforcement ply includes a first row of parallel-aligned cords and a second row of parallel-aligned cords spaced apart from the first row of parallel-aligned cords, the at least one reinforcement ply having a lower end that overlaps the at least one turn-up portion of the at least one carcass ply.

22. The tire of claim 21, wherein adjacent cords in the first row of parallel-aligned cords are spaced-apart from each other a first distance measured from the center of adjacent cords and adjacent cords in the second row of parallel-aligned cords are spaced-apart from each other a second distance measured from the center of adjacent cords.

23. The tire of claim 22, wherein the second row of parallel-aligned cords are offset from the first row of parallel-aligned cords an offset distance.

24. The tire of claim 23, wherein the offset distance is about 50% of the first distance between adjacent cords in the first row of parallel-aligned cords.

25. The tire of claim 21, wherein the second row of parallel-aligned cords is offset from the first row of parallel-aligned cords in a direction parallel to a circumferential direction of the tire.

26. The tire of claim 21, wherein the first and second set of parallel-aligned cords are constructed of a material selected from the group consisting of nylon, polyester, rayon, and steel.

27. A tire having a maximum section width, an upper section above the maximum section width, and a lower section below the maximum section width, the tire comprising:
a tread that extends circumferentially about the tire;
a pair of sidewalls;
a pair of bead assemblies, each bead portion includes a bead filler;
at least one carcass ply having radially disposed cords, the at least one carcass ply extending circumferentially about the tire from one bead portion to the other, each end of the at least one carcass ply being wound outwardly about a respective bead core and extends toward the tread to form a turn-up portion that terminates at a turn-up end; and
at least one reinforcement ply extending circumferentially about the tire and being disposed between the at least one carcass ply and the tread and sidewalls of the tire, the reinforcement ply includes a first row of parallel-aligned cords and a second row of parallel-aligned cords spaced apart from and oriented substantially parallel to the first row of parallel-aligned cords, the reinforcement ply having lower ends that terminate in the lower section of the tire below a respective turn-up end of the at least one carcass ply.

28. The tire of claim 27, wherein the second row of parallel-aligned cords is offset from the first row of parallel-aligned cords in a direction parallel to a circumferential direction of the tire.

29. The tire of claim 27, wherein the first and second row of parallel-aligned cords are constructed of polyester.
